(19) United States
(12) Patent Application Publication
(10) Pub. No.: US 2020/0262528 A1
(43) Pub. Date: Aug. 20, 2020

(54) Smart Inflatable Swimwear

(71) Applicant: Shenzhen Yitu Electronics Co., Ltd., Shenzhen (CN)

(72) Inventor: Ke DONG, Daishan (CN)

(21) Appl. No.: 16/280,516

(22) Filed: Feb. 20, 2019

(51) Int. Cl. B63C 9/20; G08B 5/36; B63C 9/00; B63C 9/125; B63C 9/19

(52) U.S. Cl. CPC B63C 9/20; G08B 5/36; H04M 1/0202; B63C 9/1255; B63C 9/19; B63C 9/00

(57) ABSTRACT

The smart inflatable swimwear gets involved in the swimwear technology area. The smart inflatable swimwear is composed of the body, gasbags, air tubes, gas cylinder, gas needle, prober, bandages, power cord and caution light. The gasbags are mounted on both sides of the front side of the body of the described swimwear which also has gasbags on the middle of the back side. The gas cylinder is mounted on the body of the swimwear on the back side under the described gasbags. The described gas cylinder is connected to the gasbags on the back side through the air tube. The described gasbags on the back side are connected to the ones on the front side through the air tube.

### FIELD OF TECHNOLOGY

The invention gets involved in the swimwear technology area and contains the technology of the smart inflatable swimwear precisely.

### BACKGROUND

At present, the functions of the swimwear sold on the market are monotonous and only used as the swimwear. The user can not be rescued if they are near-drowning. However, any one may encounter the drowning situation no matter how good they are at swimming. Therefore, it's necessary and urgent to invent a swimwear with functions of rescue and alarm in case of the drowning of the user.

### Contents of the Invention

The purpose of the invention is to make up the insufficiency and shortcomings of the existing technology. Equipped with functions of drowning alarm and rescuing the user by inflating, the swimwear is recycled, cost-saving and free from wasting.

In order to realize the above intention, the invention applies the following plan: The smart inflatable swimwear is composed of the body 1, gasbags 2, air tubes 3, gas cylinder 4, gas needle 5, prober 6, bandages 7, power cord 8 and caution light 9. The gasbags 2 are mounted on both sides of the front side of the body 1 of the described swimwear which also has gasbags 2 on the middle of the back side. The gas cylinder is mounted on the body 1 of the swimwear on the back side under the described gasbags 2. The described gas cylinder 4 is connected to the gasbags 2 on the back side through the air tube 3. The described gasbags 2 on the back side are connected to the gasbags 2 on the front side through the air tube 3. The described gasbags 4 are connected to the air tube 3 through the gas needle 5. On the left side of the described gas needle 5, there's a replaceable driving device for the gas needle 51 which can be electrically connected to the prober 6 through the power cord 8. Several bandages 7 are bound to the described prober 6. The caution light 9 is mounted on the front side of the described prober 6. The described prober is composed of the shell 61, face shell 62, integrated piece 63, clear plastic 64, lampshade 65, mainboard 66, waterproof ring 67, batteries 68, and power cord interface 69. The described face shell 62 is fixed and mounted on the shell 61. The described face shell 62 and the shell 61 form an integral shell of the prober 6. The joint of the described face shell 62 and the shell 61 has a water-proof ring 67. The integrated piece 63 is amounted on the upper side of the described face shell 62. The described integrated piece 63 is the one to integrate the button and the water-proof ring. The described integrated piece 63 has clear plastic 64 on the upper side. The bottom of the described shell has batteries 68. The mainboard 66 is mounted in the shell above the described batteries 68. The lampshade 65 is set above the described mainboard. The power cord interface 69 is mounted on the described shell. The described power cord interface is electrically connected to the mainboard 66. The described mainboard 66 is composed of the power switch 66-1, the function key 66-2, the lamp patch 66-3, headlight 66-4, singlechip 66-5, sensor 66-6, GPS module 66-7, card slot 66-8, Sim card 66-9, GPS antenna 66-10 and Sim antenna 66-11. The power switch 66-1 is set on the upper right of the front side of the mainboard 66. On the left side of the described power switch 66-1 on the mainboard, there are three function keys 66-2. The lamp patch is mounted respectively for the three function keys 66-2 and the power switch 66-1 on the lower side of the mainboard 66. The headlight 66-4 is mounted on the middle of the front side of the described mainboard 66. On the mainboard 66 on the lower side of the described headlight 66-4, there's a singlechip 66-5. On the bottom of the described mainboard 66, the sensor is mounted 66-6 and extends out of the shell. The card slot 66-8 is mounted on the middle of the back side of the described mainboard 66. On the left side of the card slot on the mainboard 66, the GPS module 66-7 is set up. On the right side of the mainboard 66 of the described card slot 66-8, the Sim card 66-9 is mounted. On the mainboard 66 of the lower side of the described GPS module 66-7, the GPS antenna 66-10 is amounted. On the mainboard of the lower side of the described Sim card 66-9, the Sim antenna 66-11 is mounted. The described mainboard 66 is electrically connected to the batteries 68 and also various parts on it. The described mainboard 66 is electrically connected to the driving device for the gas needle 51 through the power cord interface 69. The described caution light 9 is electrically connected to the mainboard 66.

The described three function keys 66-2 are respectively referring to 30 s, 45 s and 60 s keys.

The described mainboard 66 is a PCB (printed circuit board) mainboard

The described prober 6 is connected to the 4G signal of the smart phone through the Sim antenna 66-11

The described smart phone has set up APP for the detecting.

The described lamp patch 66-3, headlight 66-4 and the caution light 9 are all LED lights.

The described sensor 66-6 is a metal probe.

An air outlet is set on the described gasbags 2.

The threaded fastener and seal ring are mounted on each joint of each part of the described swimwear body 1.

The application methods of the smart inflatable swimwear are as follow:

Stage 1: The prober 6 can be fixed on the neck or head of the user by the bandages 7. After putting on the swimwear body 1, the user may switch on the power switch 66-1 of the prober 6 before they swim in the swimming pool, river, natatorium or sea. Once the power switch 66-1 is switched on, the lamp patch 66-3 under the power switch 66-1 turns green. The hardware tested to be normal and the user may use the swimwear safely in 3 s if the lamp patch 66-3 does not turn red.

Stage 2: The user may select the timer of the prober 6 according to their habit or diving ability. The described timer can be selected from 30 s, 45 s or 60 s. Each timer is related to a function key 66-2 whose lamp patch 66-3 turns on if the function key is selected and the other two lamp patch 66-3 go off. Each time a function key 66-2 is selected, the other two lamp patch 66-3 will go off. A short circuit is created when the function key 66-2 is selected and the singlechip 66-5 selects the period of the timer based on the time set by the short circuit. On account of the principle of microcurrent and amplifying the voltage and the features of the metal probe, the singlechip 66-5 is provided with the short circuit signal so that the prober 6 and the user are determined to be drown and the timer is triggered. When the time reaches the set time for the alarm, the singlechip 66-5 makes the batteries 68, mainboard 66 and LED lights conductive by internal short circuit to form a normally running lighting circuit. At the same time, the singlechip 66-5 can control the twinkling and flickering of the LED light based on the principle of disconnection and conduction by the circuit switch so that surrounding people are alerted to rescue the user who is also self-positioned.

Stage 3: The prober 6 automatically turns into the sleep mode in 5 min if it does not detect any water. All of the other functions stop working except the GPS module 66-7, Sim card 66-9 telecommunication and sensor 66-6 drowning detection function. Once the sensor 66-6 detects any water, the product will recover the normal running of the prober 6.

Stage 4: After the prober 6 runs for a while and the charging capacity of the batteries 68 is less than a certain percentage, the first key of the prober 6 in front of the user will give out red light which twinkles to remind the user of charging. Once the charging is finished, the red light turns green.

Stage 5: Keep the prober 6 in contact with the smart phone by GPS and telecommunication before the diving. The APP of the smart phone may check the position and signal connecting status of the prober 6. By receiving the navigation signal from the space, the GPS antenna 66-10 will transmit the signal to the GPS module 66-7 which will transform the signal to the data for moving and positioning required by the user and changes the data into the telecommunication mode. After that, the data will be converted into the signal data by the Sim card 66-9 and sent to the smart phone APP via the Sim antenna 66-11. You may check the using status of the prober 6 on the smart phone APP.

Stage 6: Besides, messages can be sent by the smart phone APP and received by the Sim antenna 66-11. Transformed by the Sim card 66-9, the data will be transmitted to the singlechip 66-5 that will control various operations of the prober 6 according to the software system to realize the purpose of the user.

Stage 7: The same time when the prober 6 detects the drowning, the smart phone and the product may lose the GPS and telecommunication signal, and the smart phone terminal will also start the counting. When it reaches the alarm value, the smart phone will directly turn to the APP interface and the ringtone will be triggered to alarm the phone user to rescue the product user. Besides, the smart phone APP will also display the product code, the position where the signal is lost and the position of this smart phone. The smart phone can display the mock location of it and the GPS mock location of the prober 6. The locations are overlapped to determine the precise location for the rescue. Since the GPS signal has signal drift, the error is about 3 m.

Stage 8: When the singlechip 66-5 detects the drowning of the prober 6 and the timer reaches the alarm value, the singlechip 66-5 will control the power cord to drive the batteries 68 to provide power for the body's 1 driving device for the gas needle 51 which is working in a principle of the capacitor explosion. The driving device for the gas needle 51 will be given electrolyte and the voltage several times larger than the upper limit of the driving device for the gas needle 51 so that the electrolyte in it will be overheated and gasified. It is a way of rapid expansion. After that, the expanded gas will break through the weak point of the seal and a blasting effect is created. After the blasting, the gas will further gush toward the air tubes 3 and push the gas needle 5 to dash to the seal of the gas cylinder 4 in a rapid speed. Once the seal of the gas cylinder 4 is broken through instantly, the gas in the gas cylinder 4 will be pushed to the intermediate container under the high pressure. After that, the intermediate container will then inflate the air through the air outlet of the container to the gasbags 2 of the swimwear body 1. It takes approx. 3-5 s to inflate the gasbags 2 from the gas cylinder 4. After the inflation, the product can immediately lift the user to the water surface so that the user is self-rescued.

Stage 9: Once the gasbags 2 of the swimwear body 1 complete the inflating, the air of the gasbags 2 can be unloaded through the air outlet and then the cover can be put back to the air outlet. After that, replace the driving device for the gas needle 51 by a new one and the swimwear body 1 can be recycled.

Benefits of the invention once the above technical plan is applied: When the swimwear is not inflated, it's only used as an ordinary swimwear. When the swimwear enters the water and reaches the signal value for the alarm, the air charging system will automatically inflate the swimwear. After the inflated swimwear is used, the air in the gasbags can be deflated manually and the gasbags can be recycled. It takes 3-5 s for the swimwear to be inflated so that it can float upward fast. Once the gas needle is used at a time, it can be replaced by a new one so that the product can be used next time. Equipped with functions of drowning alarm and rescuing the user by inflating, the swimwear can be recycled, cost-saving and free from wasting.

### DESCRIPTION FOR FIGURES

In order to explain the example of the invention and the existing technical plan, the following attached figures for the example or existing technical plan are displayed for the simple introduction. Obviously, the following figures are only some of the examples of the invention. For common technicians of the area, they can acquire the other figures according to the existing ones under the premise of not paying any creativity or labor.

FIG. 1 is the structure diagram of the invention.

FIG. 2 is the rear elevation of FIG. 1.

FIG. 3 is the explosive view of prober 6 of the invention.

FIG. 4 is the structure diagram of the front side of the mainboard 66 of the invention.

FIG. 5 is the structure diagram of the rear side of the mainboard 66 of the invention.

Description of the marks of the figures: Swimwear body 1, gasbags 2, air tubes 3, gas cylinder 4, gas needle 5, prober 6, bandages 7, power cord 8, caution light 9, driving device for the gas needle 51, shell 61, face shell 62, integrated piece 63, clear plastic 64, lampshade 65, mainboard 66, waterproof ring 67, batteries 68, power cord interface 69, power switch 66-1, function keys 66-2, lamp patch 66-3, headlight 66-4, singlechip 66-5, sensor 66-6, GPS module 66-7, card slot 66-8, Sim card 66-9, GPS antenna 66-10 and Sim antenna 66-11.

### Specific Implementation Mode

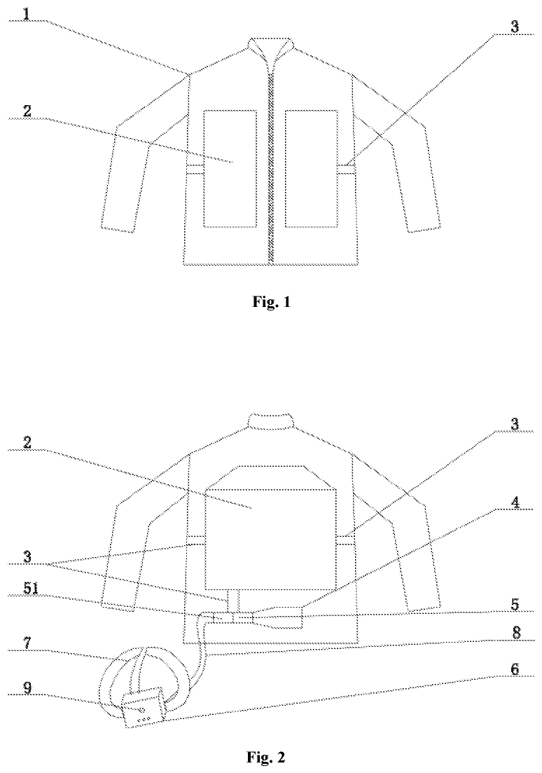

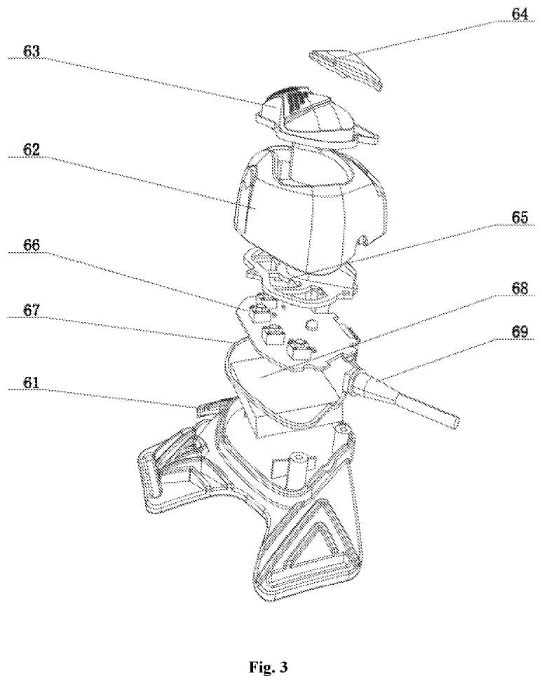

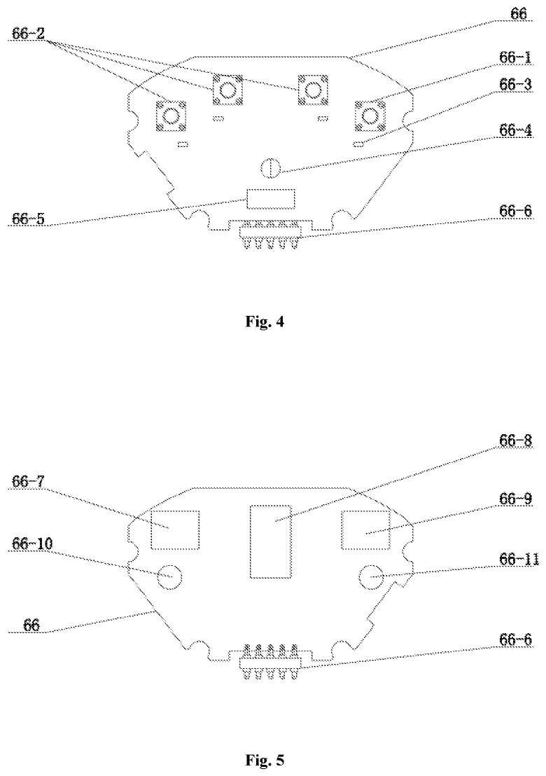

As FIG. 1-5 show, the technical plan applied for this specific implementation mode is as follows: The smart inflatable swimwear is composed of the body 1, gasbags 2, air tubes 3, gas cylinder 4, gas needle 5, prober 6, bandages 7, power cord 8 and caution light 9. The gasbags 2 are mounted on both sides of the front side of the body 1 of the described swimwear which also has gasbags 2 on the middle of the back side. The gas cylinder is mounted on the body 1 of the swimwear on the back side under the described gasbags 2. The described gas cylinder 4 is connected to the gasbags 2 on the back side through the air tube 3. The described gasbags 2 on the back side are connected to the gasbags 2 on the front side through the air tube 3. The described gasbags 4 are connected to the air tube 3 through the gas needle 5. On the left side of the described gas needle 5, there's a replaceable driving device for the gas needle 51 which can be electrically connected to the prober 6 through the power cord 8. Several bandages 7 are bound to the described prober 6. The caution light 9 is mounted on the front side of the described prober 6. The described prober is composed of the shell 61, face shell 62, integrated piece 63, clear plastic 64, lampshade 65, mainboard 66, waterproof ring 67, batteries 68, and power cord interface 69. The described face shell 62 is fixed and mounted on the shell 61. The described face shell 62 and the shell 61 form an integral shell of the prober 6. The joint of the described face shell 62 and the shell 61 has a water-proof ring 67. The integrated piece 63 is amounted on the upper side of the described face shell 62. The described integrated piece 63 is the one to integrate the button and the water-proof ring. The described integrated piece 63 has clear plastic 64 on the upper side. The bottom of the described shell has batteries 68. The mainboard 66 is mounted in the shell above the described batteries 68. The lampshade 65 is set above the described mainboard. The power cord interface 69 is mounted on the described shell. The described power cord interface is electrically connected to the mainboard 66. The described mainboard 66 is composed of the power switch 66-1, the function key 66-2, the lamp patch 66-3, headlight 66-4, singlechip 66-5, sensor 66-6, GPS module 66-7, card slot 66-8, Sim card 66-9, GPS antenna 66-10 and Sim antenna 66-11. The power switch 66-1 is set on the upper right of the front side of the mainboard 66. On the left side of the described power switch 66-1 on the mainboard, there are three function keys 66-2. The lamp patch is mounted respectively for the three function keys 66-2 and the power switch 66-1 on the lower side of the mainboard 66. The headlight 66-4 is mounted on the middle of the front side of the described mainboard 66. On the mainboard 66 on the lower side of the described headlight 66-4, there's a singlechip 66-5. On the bottom of the described mainboard 66, the sensor is mounted 66-6 and extends out of the shell. The card slot 66-8 is mounted on the middle of the back side of the described mainboard 66. On the left side of the card slot on the mainboard 66, the GPS module 66-7 is set up. On the right side of the mainboard 66 of the described card slot 66-8, the Sim card 66-9 is mounted. On the mainboard 66 of the lower side of the described GPS module 66-7, the GPS antenna 66-10 is amounted. On the mainboard of the lower side of the described Sim card 66-9, the Sim antenna 66-11 is mounted. The described mainboard 66 is electrically connected to the batteries 68 and also various parts on it. The described mainboard 66 is electrically connected to the driving device for the gas needle 51 through the power cord interface 69. The described caution light 9 is electrically connected to the mainboard 66.

The described three function keys 66-2 are respectively referring to 30 s, 45 s and 60 s keys.

The described mainboard 66 is a PCB (printed circuit board) mainboard

The described prober 6 is connected to the 4G signal of the smart phone through the Sim antenna 66-11

The described smart phone has set up APP for the detecting. The APP on the smart phone may check the last position of the product when it enters the water and the signal is lost. The smart phone may set up the alarm time of the product (The alarm time is set either by the smart phone or directly by the product). After the setting, the alarm time is synchronized both on the smart phone and the product. Switch on or off the product electricity. The product can be powered on independently if the smart phone is powered off. When the product enters water and reaches the preset alarm value, there's a ringtone ringing by the smart phone. Check the product using record, including the using time, number of using, places of using and whether there's a record of swimwear inflating reminder. Product power left reminder and the time left for the dump energy. Test whether the product hardware is normal and shows indicators. Reminder for the APP, GPS and telecommunication signal connecting message is enabled between the product and the smart phone. Check the running status of the same product on multiple smart phones. Or check the running status of multiple products on the same phone. When testing multiple products with a single smart phone, once there's any abnormality with a product, the related code of that product will come up on the APP of the smart phone. Test whether the product hardware is normal with the smart phone APP. When the smart phone is disconnected with the product signal, it immediately enters the timing status and the telecommunication recovers if it does not reach the alarm value. The timer returns to zero automatically.

The described lamp patch 66-3, headlight 66-4 and the caution light 9 are all LED lights.

The described sensor 66-6 is a metal probe.

An air outlet is set on the described gasbags 2.

The threaded fastener and seal ring are mounted on each joint of each part of the described swimwear body 1.

The application methods of the smart inflatable swimwear are as follow:

Stage 1: The prober 6 can be fixed on the neck or head of the user by the bandages 7. After putting on the swimwear body 1, the user may switch on the power switch 66-1 of the prober 6 before they swim in the swimming pool, river, natatorium or sea. Once the power switch 66-1 is switched on, the lamp patch 66-3 under the power switch 66-1 turns green. The hardware tested to be normal and the user may use the swimwear safely in 3 s if the lamp patch 66-3 does not turn red.

Stage 2: The user may select the timer of the prober 6 according to their habit or diving ability. The described timer can be selected from 30 s, 45 s or 60 s. Each timer is related to a function key 66-2 whose lamp patch 66-3 turns on if the function key is selected and the other two lamp patch 66-3 go off. Each time a function key 66-2 is selected, the other two lamp patch 66-3 will go off. A short circuit is created when the function key 66-2 is selected and the singlechip 66-5 selects the period of the timer based on the time set by the short circuit. On account of the principle of microcurrent and amplifying the voltage and the features of the metal probe, the singlechip 66-5 is provided with the short circuit signal so that the prober 6 and the user are determined to be drown and the timer is triggered. When the time reaches the set time for the alarm, the singlechip 66-5 makes the batteries 68, mainboard 66 and LED lights conductive by internal short circuit to form a normally running lighting circuit. At the same time, the singlechip 66-5 can control the twinkling and flickering of the LED light based on the principle of disconnection and conduction by the circuit switch so that surrounding people are alerted to rescue the user who is also self-positioned.

Stage 3: The prober 6 automatically turns into the sleep mode in 5 min if it does not detect any water. All of the other functions stop working except the GPS module 66-7, Sim card 66-9 telecommunication and sensor 66-6 drowning detection function. Once the sensor 66-6 detects any water, the product will recover the normal running of the prober 6.

Stage 4: After the prober 6 runs for a while and the charging capacity of the batteries 68 is less than a certain percentage, the first key of the prober 6 in front of the user will give out red light which twinkles to remind the user of charging. Once the charging is finished, the red light turns green.

Stage 5: Keep the prober 6 in contact with the smart phone by GPS and telecommunication before the diving. The APP of the smart phone may check the position and signal connecting status of the prober 6. By receiving the navigation signal from the space, the GPS antenna 66-10 will transmit the signal to the GPS module 66-7 which will transform the signal to the data for moving and positioning required by the user and change the data into the telecommunication mode. After that, the data will be converted into the signal data by the Sim card 66-9 and sent to the smart phone APP via the Sim antenna 66-11. You may check the using status of the prober 6 on the smart phone APP.

Stage 6: Besides, messages can be sent by the smart phone APP and received by the Sim antenna 66-11. Transformed by the Sim card 66-9, the data will be transmitted to the singlechip 66-5 that will control various operations of the prober 6 according to the software system to realize the purpose of the user.

Stage 7: The same time when the prober 6 detects the drowning, the smart phone and the product may lose the GPS and telecommunication signal, and the smart phone terminal will also start the counting. When it reaches the alarm value, the smart phone will directly turn to the APP interface and the ringtone will be triggered to alarm the phone user to rescue the product user. Besides, the smart phone APP will also display the product code, the position where the signal is lost and the position of this smart phone. The smart phone can display the mock location of it and the GPS mock location of the prober 6. The locations are overlapped to determine the precise location for the rescue. Since the GPS signal has signal drift, the error is about 3 m.

Stage: When the singlechip 66-5 detects the drowning of the prober 6 and the timer reaches the alarm value, the singlechip 66-5 will control the power cord to drive the batteries 68 to provide power for the body's 1 driving device for the gas needle 51 which is working in a principle of the capacitor explosion. The driving device for the gas needle 51 will be given electrolyte and the voltage several times larger than the upper limit of the driving device for the gas needle 51 so that the electrolyte in it will be overheated and gasified. It is a way of rapid expansion. After that, the expanded gas will break through the weak point of the seal and a blasting effect is created. After the blasting, the gas will further gush toward the air tubes 3 and push the gas needle 5 to dash to the seal of the gas cylinder 4 in a rapid speed. Once the seal of the gas cylinder 4 is broken through instantly, the gas in the gas cylinder 4 will be pushed to the intermediate container under the high pressure. After that, the intermediate container will then inflate the air through the air outlet of the container to the gasbags 2 of the swimwear body 1. It takes approx. 3-5 s to inflate the gasbags 2 from the gas cylinder 4. After the inflation, the product can immediately lift the user to the water surface so that the user is self-rescued.

Stage 9: Once the gasbags 2 of the swimwear body 1 complete the inflating, the air of the gasbags 2 can be unloaded through the air outlet and then the cover can be put back to the air outlet. After that, replace the driving device for the gas needle 51 by a new one and the swimwear body 1 can be recycled.

Benefits of the invention once the above technical plan is applied: When the swimwear is not inflated, it's only used as an ordinary swimwear. When the swimwear enters the water and reaches the signal value for the alarm, the air charging system will automatically inflate the swimwear. After the inflated swimwear is used, the air in the gasbags can be deflated manually and the gasbags can be recycled. It takes 3-5 s for the swimwear to be inflated so that it can float upward fast. Once the gas needle is used at a time, it can be replaced by a new one so that the product can be used next time. Equipped with functions of drowning alarm and rescuing the user by inflating, the swimwear can be is recycled, cost-saving and free from wasting.

All of the above descriptions mean to illustrate the technical plan of the product rather than to make restrictions. All of the revisions or equivalent replacements made by the ordinary technicians of the same field should be contained in the Claims of the invention as long as they do not deviate from the contents and scope of the technical plan.

1. A smart inflatable swimwear, comprising a body (1), gasbags (2), air tubes (3), gas cylinder (4), gas needle (5), prober (6), bandages (7), power cord (8) and caution light (9), wherein the gasbags (2) are mounted on both sides of the front side of the body (1) of the described swimwear which also has gasbags (2) on the middle of the back side, wherein the gas cylinder is mounted on the body (1) of the swimwear on the back side under the described gasbags (2), wherein the described gas cylinder (4) is connected to the gasbags (2) on the back side through the air tube (3), wherein the described gasbags (2) on the back side are connected to the gasbags (2) on the front side through the air tube (3). The described gasbags (4) are connected to the air tube (3) through the gas needle (5), wherein on the left side of the described gas needle (5), there's a replaceable driving device for the gas needle (51) which can be electrically connected to the prober (6) through the power cord (8). Several bandages (7) are bound to the described prober (6), wherein the caution light (9) is mounted on the front side of the described prober (6), wherein the described prober is composed of the shell (61), face shell (62), integrated piece (63), clear plastic (64), lampshade (65), mainboard (66), waterproof ring (67), batteries (68), and power cord interface (69), wherein the described face shell (62) is fixed and mounted on the shell (61), wherein the described face shell (62) and the shell (61) form an integral shell of the prober (6) wherein the joint of the described face shell (62) and the shell (61) has a water-proof ring (67) wherein the integrated piece (63) is amounted on the upper side of the described face shell (62), wherein the described integrated piece (63) is the one to integrate the button and the water-proof ring, wherein the described integrated piece (63) has clear plastic (64) on the upper side, wherein he bottom of the described shell has batteries (68), wherein the mainboard (66) is mounted in the shell above the described batteries (68), wherein the lampshade (65) is set above the described mainboard, wherein the power cord interface (69) is mounted on the described shell, wherein the described power cord interface is electrically connected to the mainboard (66) wherein the described mainboard (66) is composed of the power switch (66-1), the function key (66-2), the lamp patch (66-3), headlight (66-4), singlechip (66-5), sensor (66-6), GPS module (66-7), card slot (66-8), Sim card (66-9), GPS antenna (66-10) and Sim antenna (66-11), wherien the power switch (66-1) is set on the upper right of the front side of the mainboard (66), wherein on the left side of the described power switch (66-1) on the mainboard, there are three function keys (66-2), wherien the lamp patch is mounted respectively for the three function keys (66-2) and the power switch (66-1) on the lower side of the mainboard (66), wherein the headlight (66-4) is mounted on the middle of the front side of the described mainboard (66), wherein on the mainboard (66) on the lower side of the described headlight (66-4), there's a singlechip (66-5), wherein on the bottom of the described mainboard (66), the sensor is mounted (66-6) and extends out of the shell, wherein the card slot (66-8) is mounted on the middle of the back side of the described mainboard (66). On the left side of the card slot on the mainboard (66), the GPS module (66-7) is set up, wherein on the right side of the mainboard (66) of the described card slot (66-8), the Sim card (66-9) is mounted, wherein on the mainboard (66) of the lower side of the described GPS module (66-7), the GPS antenna (66-10) is amounted, wherein on the mainboard of the lower side of the described Sim card (66-9), the Sim antenna (66-11) is mounted, wherein the described mainboard (66) is electrically connected to the batteries (68) and also various parts on it, wherein the described mainboard (66) is electrically connected to the driving device for the gas needle (51) through the power cord interface (69), wherein the described caution light (9) is electrically connected to the mainboard (66).

2. The smart inflatable swimwear of claim 1, wherein the three function keys (66-2) are respectively referring to 30 s, 45 s and 60 s keys.

3. The smart inflatable swimwear of claim 1, wherein the described mainboard (66) is a PCB (printed circuit board) mainboard

4. The smart inflatable swimwear of claim 1, wherein the described prober (6) is connected to the 4G signal of the smart phone through the Sim antenna (66-11)

5. The smart inflatable swimwear of claim 1, wherein the described smart phone has set up APP for the detecting.

6. The smart inflatable swimwear of claim 1, wherein the described lamp patch (66-3), headlight (66-4) and the caution light (9) are all LED lights.

7. The smart inflatable swimwear of claim 1, wherein the described sensor (66-6) is a metal probe.

8. The smart inflatable swimwear of claim 1, wherein an air outlet is set on the described gasbags (2).

9. The smart inflatable swimwear of claim 1, wherein the threaded fastener and seal ring are mounted on each joint of each part of the described swimwear body (1).

10. A method for making smart inflatable swimwear, comprising the following:
Stage 1: The prober (6) can be fixed on the neck or head of the user by the bandages (7); after putting on the swimwear body (1), the user may switch on the power switch (66-1) of the prober (6) before they swim in the swimming pool, river, natatorium or sea; once the power switch (66-1) is switched on, the lamp patch (66-3) under the power switch (66-1) turns green; the hardware tested to be normal and the user may use the swimwear safely in 3 s if the lamp patch (66-3) does not turn red;
Stage 2: the user may select the timer of the prober (6) according to their habit or diving ability; the described timer can be selected from 30 s, 45 s or 60 s; each timer is related to a function key (66-2) whose lamp patch (66-3) turns on if the function key is selected and the other two lamp patch (66-3) go off; each time a function key (66-2) is selected, the other two lamp patch (66-3) will go off; a short circuit is created when the function key (66-2) is selected and the singlechip (66-5) selects the period of the timer based on the time set by the short circuit; on account of the principle of microcurrent and amplifying the voltage and the features of the metal probe, the singlechip (66-5) is provided with the short circuit signal so that the prober (6) and the user are determined to be drown and the timer is triggered; when the time reaches the set time for the alarm, the singlechip (66-5) makes the batteries (68), mainboard (66) and LED lights conductive by internal short circuit to form a normally running lighting circuit; at the same time, the singlechip (66-5) can control the twinkling and flickering of the LED light based on the principle of disconnection and conduction by the circuit switch so that surrounding people are alerted to rescue the user who is also self-positioned;
Stage 3: The prober (6) automatically turns into the sleep mode in 5 min if it does not detect any water; all of the other functions stop working except the GPS module (66-7), Sim card (66-9) telecommunication and sensor (66-6) drowning detection function; once the sensor (66-6) detects any water, the product will recover the normal running of the prober (6);
Stage 4: After the prober (6) runs for a while and the charging capacity of the batteries (68) is less than a certain percentage, the first key of the prober (6) in front of the user will give out red light which twinkles to remind the user of charging; once the charging is finished, the red light turns green;
Stage 5: Keep the prober (6) in contact with the smart phone by GPS and telecommunication before the diving; the APP of the smart phone may check the position and signal connecting status of the prober (6); by receiving the navigation signal from the space, the GPS antenna (66-10) will transmit the signal to the GPS module (66-7) which will transform the signal to the data for moving and positioning required by the user and changes the data into the telecommunication mode; after that, the data will be converted into the signal data by the Sim card (66-9) and sent to the smart phone APP via the Sim antenna (66-11); You may check the using status of the prober (6) on the smart phone APP;
Stage 6: Besides, messages can be sent by the smart phone APP and received by the Sim antenna (66-11); transformed by the Sim card (66-9), the data will be transmitted to the singlechip (66-5) that will control various operations of the prober (6) according to the software system to realize the purpose of the user;
Stage 7: The same time when the prober (6) detects the drowning, the smart phone and the product may lose the GPS and telecommunication signal, and the smart phone terminal will also start the counting; when it reaches the alarm value, the smart phone will directly turn to the APP interface and the ringtone will be triggered to alarm the phone user to rescue the product user; besides, the smart phone APP will also display the product code, the position where the signal is lost and the position of this smart phone; the smart phone can display the mock location of it and the GPS mock location of the prober (6); the locations are overlapped to determine the precise location for the rescue; since the GPS signal has signal drift, the error is about 3 m;
Stage: 8 When the singlechip (66-5) detects the drowning of the prober (6) and the timer reaches the alarm value, the singlechip (66-5) will control the power cord to drive the batteries (68) to provide power for the body's (1) driving device for the gas needle (51) which is working in a principle of the capacitor explosion; the driving device for the gas needle (51) will be given electrolyte and the voltage several times larger than the upper limit of the driving device for the gas needle (51) so that the electrolyte in it will be overheated and gasified; it is a way of rapid expansion; after that, the expanded gas will break through the weak point of the seal and a blasting effect is created; after the blasting, the gas will further gush toward the air tubes (3) and push the gas needle (5) to dash to the seal of the gas cylinder (4) in a rapid speed; once the seal of the gas cylinder (4) is broken through instantly, the gas in the gas cylinder (4) will be pushed to the intermediate container under the high pressure; after that, the intermediate container will then inflate the air through the air outlet of the container to the gasbags (2) of the swimwear body (1); it takes approx. 3-5 s to inflate the gasbags (2) from the gas cylinder (4); after the inflation, the product can immediately lift the user to the water surface so that the user is self-rescued;
Stage 9: Once the gasbags (2) of the swimwear body (1) complete the inflating, the air of the gasbags (2) can be unloaded through the air outlet and then the cover can be put back to the air outlet; after that, replace the driving device for the gas needle (51) by a new one and the swimwear body (1) can be recycled.
